(19) United States
(12) Patent Application Publication
(10) Pub. No.: US 2007/0040301 A1
(43) Pub. Date: Feb. 22, 2007

(54) Zoned stretching of a web

(75) Inventor: Byron M. Jackson, Forest Lake, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/207,505

(22) Filed: Aug. 19, 2005

(51) Int. Cl. B29C 55/08

(52) U.S. Cl. 264/290.2; 425/335

(57) ABSTRACT

There is provided an apparatus and methods for stretching one or more zones of a web and webs including one or more stretched zones. Each of the stretched zones in the web is stretched in the cross-web direction, i.e., the direction transverse to the downweb direction. The stretching can be performed continuously on the web as the web is advancing through the apparatus in the down-web direction. The method for stretching an extensible web in the cross direction generally is practiced on a substantially continuous cross-directional extensible web. The web is traveling in a first downweb direction at a first speed. The extensible web has a width and substantially continuous length in the first downweb direction. The crossweb stretching occurs in an orientation zone established between at least two moving nip points. The nip points are in a plane of the web with a leading nip downweb of a trailing nip with the at least two nips offset in the cross direction. The leading nip moves at a faster speed than the trailing nip, where the degree of crossweb orientation in the orientation zone is proportional at least to a ratio of the leading nip speed to the trailing nip speed.

### FIELD OF THE INVENTION

The present invention relates to the field of webs, web processing methods, and web processing apparatus. More particularly, the present invention provides apparatus and methods for stretching one or more zones of a web in the cross-web direction and webs so stretched.

### BACKGROUND

It is desirable in many instances to stretch a web in the cross-web direction (it is noted that cross direction, cross-web direction and cross machine direction are used interchangeably) during processing. For example, webs including layers of inelastic materials, e.g., nonwoven webs, laminated or otherwise attached to elastic layers while the elastic is not extended typically require stretching to impart elasticity to the web. The web is stretched so that the inelastic layers, or bonds within the inelastic layer or layers, are broken or otherwise disrupted allowing the elastic to freely stretch which leaves the stretched web laminate elastic. Such stretching to impart elasticity to a web is commonly referred to as “activation” of the web (with the elasticity of the web being “activated” by the stretching). Activation can be done in the machine direction of the web or the cross direction of the web or both. Cross direction stretching or activation can be performed by a variety of known methods including, for example, tentering and ring rolling.

Tentering typically involves grasping the edges of a web and stretching the web in the cross-web direction while advancing the web in the downweb direction (i.e., along the length of the web). Although tentering does provide the ability to vary the amount of strain induced in the web, it also suffers from a number of disadvantages. For example, the edges of the web must often be discarded after tentering due to damage or inconsistent strain in the web at the edges. Another potential disadvantage is that it may be difficult or impossible to induce strain into selected portions or zones of a web using tentering. Further, tentering equipment can be both costly, complex, and may require significant amounts of floor space to operate as the web expands in the cross direction during the process.

Ring rolling is an alternative to tentering for stretching a web in the cross direction. Various ring rolling apparatus are described in, e.g., U.S. Pat. No. 4,223,059 (Schwarz); U.S. Pat. No. 4,968,313 (Sabee); U.S. Pat. No. 5,143,679 (Weber et al.); U.S. Pat. No. 5,156,793 (Buell et al.); and U.S. Pat. No. 5,167,897 (Weber). Ring rolling or incremental stretching refers generally to placing the web between rolls having interengaging teeth. The engaging teeth stretch the web based generally on the size, number and pitch of the teeth. Ring rolling can be used to stretch selected zones in a web and stretch only in the cross direction. However ring rolling teeth grip the web and this contact of the web by the ring rolling apparatus can tear the web and undesirably affect the web's appearance. The amount of strain that can be induced in a web using ring rolling is limited by the specific ring rolls used. Adjustment or change in the degree of stretch requires new ring rolls to be machined. This is of course costly and inflexible.

### SUMMARY OF THE INVENTION

The present invention provides apparatus and methods for stretching one or more zones of a web and webs including one or more stretched zones. Each of the stretched zones in the web is stretched in the cross-web direction, i.e., the direction transverse to the downweb direction. The stretching can be performed continuously on the web as the web is advancing through the apparatus in the down-web direction.

The method for stretching an extensible web in the cross direction generally is practiced on a substantially continuous cross-directional extensible web. The web is traveling in a first downweb direction at a first speed. The extensible web has a width and substantially continuous length in the first downweb direction. The crossweb stretching occurs in an orientation zone established between at least two moving nip points. The nip points are in a plane of the web with a leading nip downweb of a trailing nip with the at least two nips offset in the cross direction. The leading nip moves at a faster speed than the trailing nip, where the degree of crossweb orientation in the orientation zone is proportional at least to a ratio of the leading nip speed to the trailing nip speed.

### BRIEF DESCRIPTION OF THE DRAWINGS

FIG. 1 is a schematic view of an apparatus for performing the invention method and producing the invention webs.

FIG. 1a is a top view of the wheels used in the apparatus of FIG. 1

FIG. 2 is a top view of a web being processed through a first embodiment orientation unit of the present invention.

FIG. 3 is a perspective view of a web being processed through a first embodiment orientation unit of the present invention.

FIG. 4 is a perspective view of a web being processed through a second embodiment orientation unit of the present invention.

FIG. 5 is a perspective view of a third embodiment orientation unit of the present invention where nip zones are created by belts.

FIG. 6 is a side view of the FIG. 5 embodiment.

FIG. 7 is a segmented top view of the FIG. 5 embodiment.

FIG. 8 is a graph showing hysteresis properties of a web processed in a first embodiment type apparatus.

FIG. 9 is a graph showing hysteresis properties of a web processed in a third embodiment type apparatus

### DESCRIPTION OF THE PREFERRED EMBODIMENTS

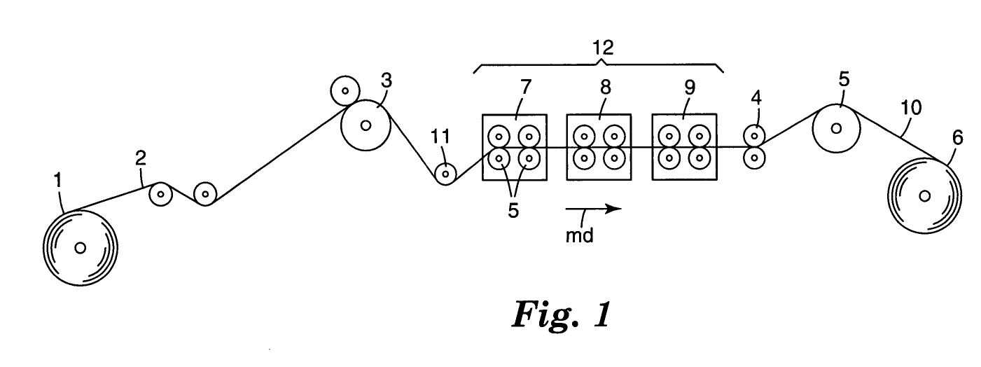

As shown in FIG. 1, web 2 is unwound from a supply source 1 which can be a roll of web material. The web 2 tension is maintained between a driven roll 3 and a driven roll 4, which establishes the speed of the web 2 through the orientation apparatus 12. The orientation apparatus 12 can include one or more orientation units 7, 8, and/or 9. Spreader bars or rolls 11 can be used at various locations to ensure that the web maintains a desired flat profile into and out of the orientation apparatus 12 or between individual orientation units 7, 8, and/or 9 (not shown). The oriented web 10 is then taken over idler rolls 5 as needed and collected in a suitable form such as on a roll 6. Generally in the above process, the web is traveling in downweb direction (md) at a first speed. The stretching occurs in one or more, orientation zones established between at least two nips, where there is a faster downweb nip and a slower trailing nip, cooperating to form the orientation zone. By nip it is meant a nip point or nip zone that either drives or restrains the web as it is traveling in the downweb direction. The restraining slower trailing nip can be at a speed slower or equal to the overall web speed to prevent downweb direction orientation. However the trailing nip can be at a speed faster than the overall web speed which could result in some downweb orientation. To establish an orientation zone, there only needs to be a speed differential between the at least two nip points forming the orientation zone.

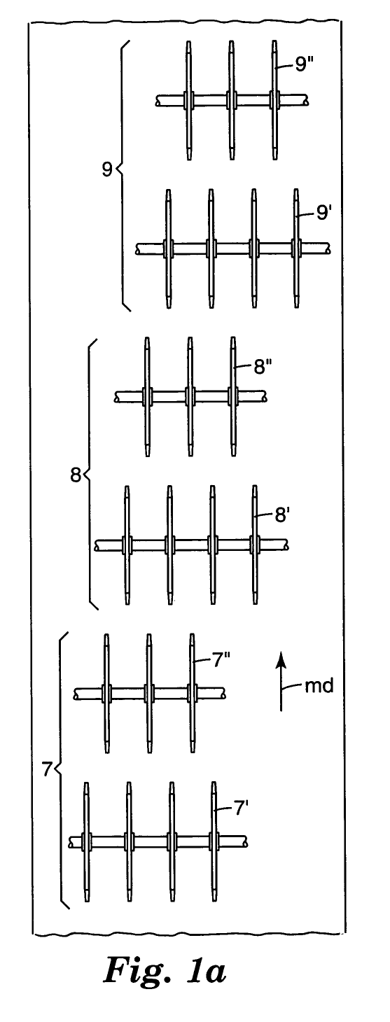

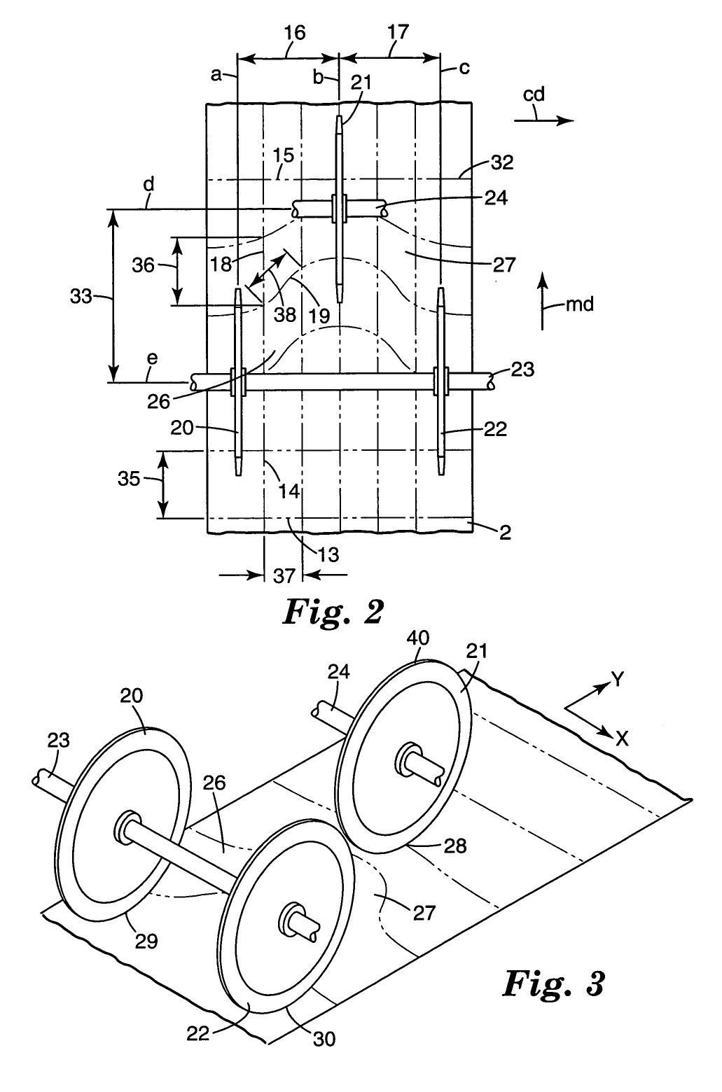

Two orientation zones 26, 27 are shown diagrammatically in FIGS. 2 and 3. The orientation zone 26 is bounded by lines a, b, d and e. The orientation zone 27 is bounded by lines b, c, d and e. Wheel 21 forms a nip point 28 in cooperation with an underlying wheel or roller (not shown). This nip point 28 acts as a leading nip point to two trailing nip points 29 and 30, formed by wheels 20 and 22, respectively. The nip points 29 and 30 would be formed by wheels 20 and 22 in cooperation with underlying wheels or rollers (not shown). The wheels 20, 21, and 22 could be driven, individually or in combination, or the underlying wheels or rollers could be driven, or both. The leading nip point 28 in cooperation with the trailing nip points 29 and 30 forms two orientation zones 26 and 27. This arrangement creates two side by side orientation zones 26, 27, which in cooperation with other nips could create more orientation zones.

There can be one or more orientation zones formed relative to the web in the crossweb direction, each formed by similar pairs of nips. Each of these orientation zones could be the same or different. Different orientation zones could be created by different speeds of the nips, different spacings of nips or the like. Multiple orientation zones could be arranged using a continuous series of nips forming a large composite orientation zone. Alternatively the nips forming the orientation zones could be spaced apart, leaving discrete areas of the web unoriented between discrete orientation zones. Orientation zones could also be arranged downweb of each other in either an overlapping or nonoverlapping relationship. By overlapping it is meant the two orientation zones activate to some extent the same crossweb zone or region of the web sequentially. Overlapping orientation zones would allow additional orientation to be imparted to specific regions, for example at steadily increasing orientation levels to provide for a gentler incremental stretching of a specific zone or region in the web.

In a first embodiment orientation unit, shown in FIGS. 2 and 3 (and the other disclosed embodiments), the nips are in a plane on the web. The orientation in the orientation zone between the nips does not occur by moving the web out of plane. Rather, a shear force is created between the leading and trailing nips, which are offset by some distance (16 or 17) in the crossweb direction, due to the speed differential between the leading and trailing nip points. This offset distance 16 or 17 defines the orientation zone width and could be any distance. However, closer spacing of the offset distance is preferred to increase the degree of orientation. Preferably, the leading edge of a leading nip is also located a distance 33 downweb of the leading edge of a trailing nip, although they need not be downweb of each other.

In operation the web behind the faster leading nip is advanced unrestrained in the downweb direction relative to the slower trailing nips. The offset or spacing of the trailing nip points in the cross direction allows the opposing portion of the web, adjacent the slower upweb nip, and directly upweb of the first nip, to travel unrestrained toward the leading nip. Namely the web directly upweb of the faster leading nip 28 is allowed to advance unrestrained toward that nip 28 so that there is little or no machine direction (MD) orientation of the web. However, the web in the cross direction is subjected to an orientation force. This force is created by the speed differential between the two nip points 29 and 28 or 30 and 28, respectively, which is translated into a cross directional stretching force. This occurs as the web between the two nip points (29 and 28 or 30 and 28, respectively) is in essence rotated between the two nips creating a crossweb orientation force or draw. The rotated web is then drawn toward the faster nip creating the crossweb stretching as shown in FIGS. 2 and 3. The details of this orientation are illustrated in idealized form by phantom line segments 13, 14, 18, 19 and 15 on web 2 as shown in FIGS. 2 and 3. The line segments 14 and 13 show idealized dimensions of the web 2 in the machine and cross direction, respectively, before the web enters the orientation zone 26 formed by downweb nip 28 and the nip 29. The line segments 18 and 19 show the dimension of the webs in the machine and cross machine direction in the orientation zone 17. The length 35 of the line segment 14 of the web 2 outside of the orientation zone 26 is substantially the same as the length 36 of the line segment 18 within the orientation zone 26. This is true for the web throughout the orientation zone. In contrast, the width 37 of line segment 13 of the web in the cross direction does substantially change outside the orientation zone 26 as compared to the dimension 38 of the line segment 19 within the orientation zone 26. This change in length is not in the width dimension of the overall web, but rather the web rotates and extends between the two nips 28 and 29, and/or 28 and 30, resulting in the width dimension 37 being drawn by the leading nip 28 pulling the web forward in the downweb direction. As soon as the web 2 leaves the orientation zone 26 the line segment 15 of the web generally goes back to its original dimension 37 in the width or cross direction (CD), if it is a web having an elastic layer and hence a retraction force, excluding and permanent set due to the nature of the web.

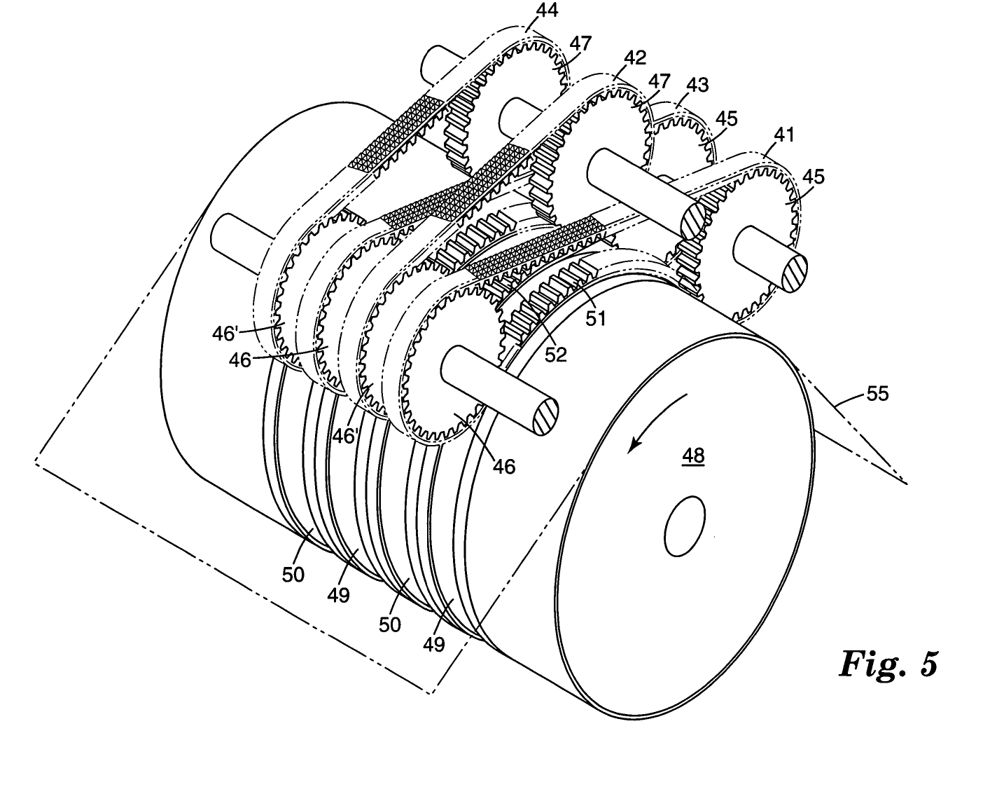

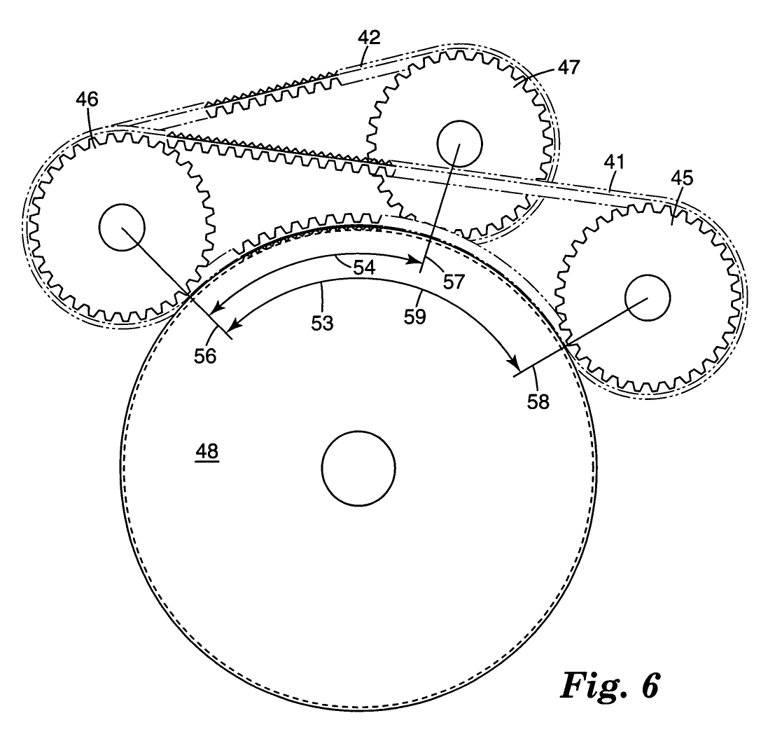

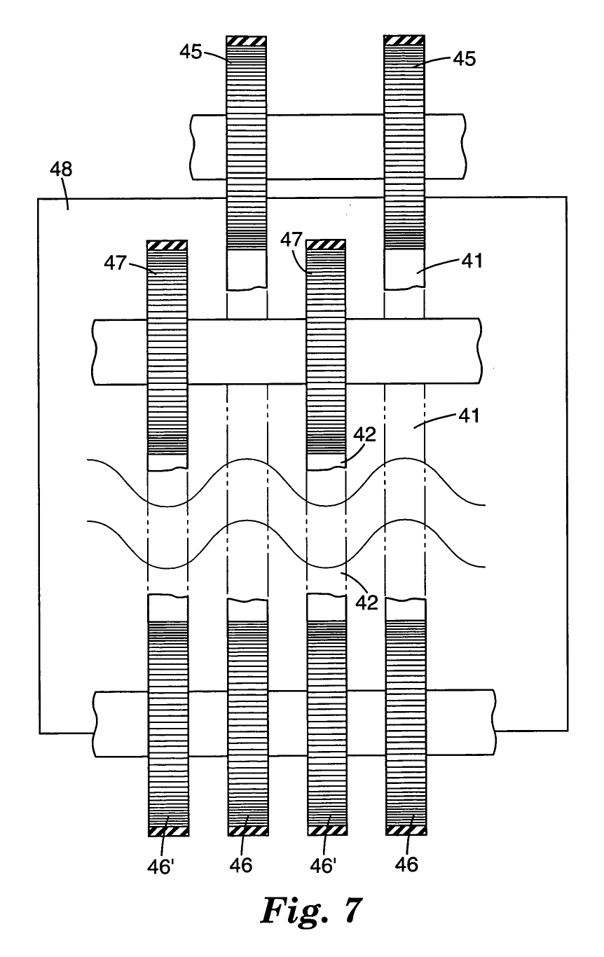

In the embodiment of FIGS. 5-7 the nips are nip zones 51 and 52 formed between nip belts 41 and 42, respectively, and underlying roll 48. The roll 48 has at least two attached wheels 49 and 50 which engage with the belts 41 and 42, respectively, to form the nip zones 53 and 54 respectively. With each nip zone 53 and 54 the speed will be determined by the driven roll 48 (which can drive wheels 49 and/or 50) and/or a driven belt, 41 and 42, generally for opposing belts and wheels both will not be driven, rather one or the other would be driven and the opposing belt or wheel would be freely rotatable. The wheels 49 and 50 would generally be annular wheels, which can either be fixed to roll 48 or be freely rotatable. The belts 41 and 42 can also be freely rotatable or driven by either or both of gears 45 and 46 or 47 and 46′. The web 55 generally engages with the slower trailing nip zone 53 which extends by a given length 49. The leading nip zone 54 extends by a second given length, which generally is less than the length of the first leading nip zone. The orientation created in the orientation zone formed by the two nip zones 53 and 54 will be related to the speed difference between the two nip zones as discussed above but also by the length of the leading nip zone 54 where it is cooperating with the trailing nip zone 53. In FIG. 6, this is the distance between point 57 and 56 as both nip zones end at point 56 and the overlapping region for the two nip zones start at point 57. With this embodiment, the orientation zone has a length identical to the length of leading nip zone 54. This orientation zone length could be any length but practically would be from 0 to 1 m or 0.01 to 0.5 m. As shown in FIG. 5, there can be more than one orientation zone relative to the web just as in the first embodiment discussed above. As shown in FIG. 5, the orientation belts are closely spaced but they could be spaced just as in the first embodiment.

The operation of the orientation unit of FIG. 5 would be identical to that of the first embodiment except that the speed differential would be a multiple of the length of the orientation zone resulting in substantially higher orientation levels. Generally, for a given degree of cross web separation, the degree of orientation is determined by the length of time the web is in the orientation zone. This length of time is generally determined by the speed of the leading nip and the length of the leading nip zone (speed divided by length). The degree of orientation is then determined by the speed differential between the leading and trailing nip times the time the web is in the orientation zone.

The degree of crossweb orientation is generally proportional to a ratio of the leading nip speed to the trailing nip speed and also the length of the orientation zone. The ratio of leading nip speed to a trailing nip speed is generally at least 1.1 or at least 1.2. This ensures at least some orientation between the two nips. Generally at least 10 percent orientation is desired, or at least 50 percent. The ratio of the leading nip speed to the trailing nip speed is generally less than 10 to 1 or less than 5 to 1. With large orientation zones, the ratio of the leading to trailing nip speed can be slower, lowering the chance of distortion while obtaining potentially higher levels of orientation. If the speed ratio is too high the web is subject to distortion and tearing.

The leading nip and trailing nip need not be separated in the downweb direction, but could be separated by at least 0.1 cm or 1 cm or 2 cm and separated in the crossweb direction by at least 0.5 cm or 1 cm or 2 cm, or are separated in the downweb direction by 0.1 to 20 cm and in the crossweb direction by 0.5 to 20 cm or 0.5 to 10 cm. The crossweb separation 16 or 17 spreads out the orientation over a larger area. The crossweb separation of the nips allows the orientation to occur preferentially in the cross direction. With greater crossweb separation, less residual downweb or machine direction orientation is likely to occur. Large crossweb separation of an individual orientation zone spreads the orientation over a larger portion of the web. Orientation over extended cross directional regions of the web can also be done by using multiple orientation zones placed side by side, such as shown partially in FIGS. 2 and 3. There are generally no space limitations as with traditional tentering devices, as the nips forming the orientation zones do not extend the web out of plane or in the cross direction.

Orientation of inelastic webs can be facilitated by heating the web within the orientation zone. This could be done by hot air, heated rolls, radiation heating or the like.

As discussed above there can be two or more orientation zones provided in the cross direction of the web and two or more orientation zones provided in the downweb direction where the two or more orientation zones provided in the downweb direction can overlap at least in part. Generally the two or more orientation zones are in the same plane, but if desired they could be in different planes. For example, the web could be driven in the form of a zigzag arrangement to save on space with alternating orientation zones in the downweb direction, forming legs of the zigs and the zags. However, the invention method does not rely on moving one portion of the web out of plane from another portion of the web to create orientation or stretch. Also the invention stretching occurs in the absence of physical contact within the orientation zone of the web. That lack of physical contact may prevent distortion or marking of the web during stretching. Another potential advantage of the apparatus and methods of the present invention is that strain induced on web layers in the oriented zones can be introduced gradually by use of multiple orientation zones arranged downweb of one another whereas rapid stretching of a zone could result in tearing or rupture of the web or web layers.

Another advantage of the apparatus and methods of the present invention is that the amount of orientation may be easily adjusted, even while the web is being processed, without requiring equipment changes. This ability to adjust orientation on the fly or dynamically may be especially useful if, e.g., coupled with a feedback control system that monitors the orientation or other characteristics to maintain desired properties in the stretched webs, related to a set of predetermined desired end properties and/or changes in the input or output web. It may also be useful in starting up the process because the web may be threaded through the apparatus with no stretch being induced, followed by gradually increasing the stretch amount as the web moves through the device.

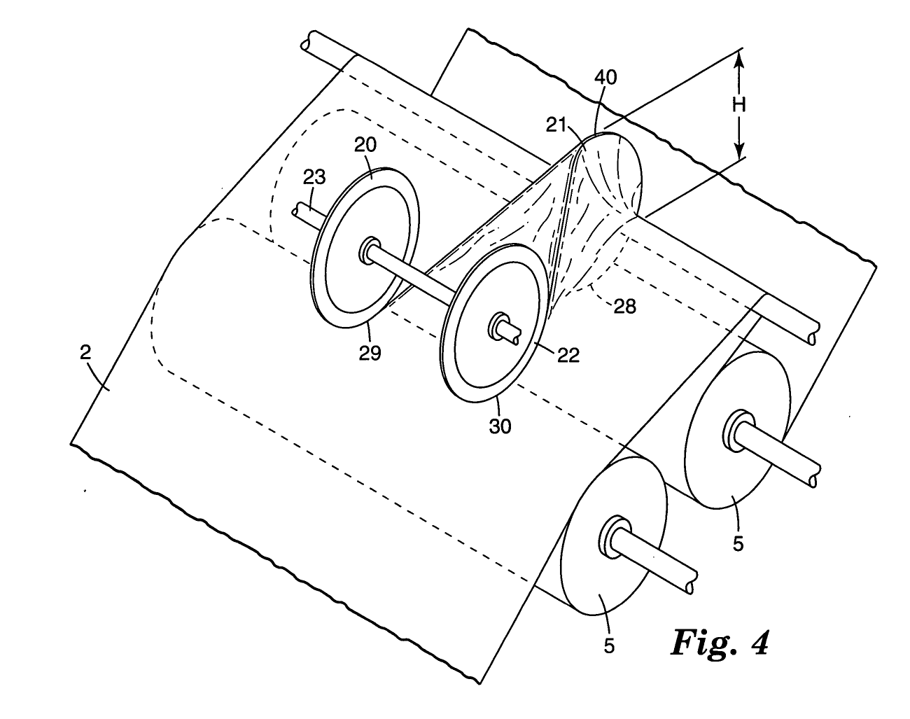

FIG. 4 is an alternative embodiment where secondary orientation is created by wrapping the web 2 around the wheel 21. This creates a secondary orientation effect by diversion of the web out of the webpath created between the leading nip point 28 and the trailing nip points 29 and 30. In this case the wheel 21 is also acting as a web diversion device. Other web diversion devices could also be used between the leading nip point 28 and the trailing nip points 29 and 30. The degree of diversion (H) from the overall webpath generally determines the amount of cross directional stretch that can occur. However the duration of the diversion and its rate of change, from no diversion to the end diversion (H), also can affect the orientation effect. If the overall degree of diversion (H) is too high there will be greater risk of downweb orientation (md direction) of the web and increased risk that the web might break or suffer damage. The diversion unit can have a profile or create a diversion path that generally gradually increases to an apex 40 to help decrease the strain rate and providing for gentler orientation.

The diversion device could be any shape or form and could be, for example, a ramp having a gradual increase to an apex. This ramp could be a solid stationary tool or be formed by one or more discrete elements, wheels, rollers or the like. The diversion device could also be provided as one or more adjacent units, which could be integral or mechanically isolated units.

A wheel type diversion device, as is the wheel 21, can rotate in a preferred embodiment, but could also be stationary if it is a separate unit other than nip wheel 21. The wheel could have flat faces, or could have a profile in the X direction. The edge of the wheel in contact with the web preferably is rounded to avoid sharp edges tearing the web. With a wheel type diversion device, the web material will wrap around the wheel over some area. This wrap is determined by the direction of the web being fed onto the wheel, which is determined by the position of the rolls 20 and 22 or other device from which the web is fed into the diversion device as well as the leading nip 28 into which the web is fed. This wrap could be from 5 to 300 degrees or 10 to 90 degrees. The height (H) of the apex 40 of the diversion device over the web path could be any value as long as it allows for diversion of the web but generally would be from 1 to 100 cm, or from 5 to 20 cm, which determines the degree of diversion.

The extensible web is in a preferred embodiment a laminate of an elastically extensible web and one or more relatively inelastic webs. In this case the orientation apparatus and methods of the present invention can be used to “activate” zones in a web such that the activated zones exhibit preferential cross direction elasticity after activation. Activation is stretching a web such that inelastic layers, or bonds within the inelastic layer or layers, are broken or otherwise disrupted, thereby leaving the stretched portion of the web elastic due to, e.g., the elastic materials or layers located within the laminate, which recover after the activation stretching. The inelastic layer or layers which are now broken or otherwise disrupted do not provide significant resistance to subsequent elastic extensions of the web. As used herein, an inelastic zone in a web is “activated” if it has been stretched such that, after stretching, the stretched zone of the web exhibits at least some elastic behavior. By elastic behavior, it is meant that, after stretching of an activated zone, the activated zone returns at least in part to its relaxed dimension in the absence of any constraining forces.

An orientation device used to stretch portions of a web in accordance with the invention can be used in-line with other web processing equipment or can easily be placed in an existing multifunctional line such as a diaper line. For example, the web processing apparatus may be located downstream of an apparatus that may, for example, process a pre-existing web by, e.g., heating, cooling, calendering, applying materials to an existing web (e.g., laminating a material by heat, ultrasonics, hot melt or pressure sensitive adhesives), etc. In some instances, the apparatus may manufacture a web (by, e.g., extrusion, spun-bonding, carding, melt blowing, weaving, laminating a nonwoven or other inelastic web to an elastic web, etc.) that is then directed as is or in a laminated form into a web processing apparatus according to the present invention.

The web processing apparatus according to the present invention may also be located upstream of another processing apparatus that acts on the web after portions of the web have been stretched according to the principles of the present invention. For example, apparatus for slitting, perforating, and/or aperturing the web at one or more locations or apparatus for laminating materials to the web (e.g., such as attaching fastener materials such as hooks), die cutting, etc. An orientation device, in accordance with the invention could easily be placed in an assembly line, such as a diaper assembly line, to specifically orient or activate certain predetermined cross direction zones.

As briefly addressed above, the present invention can be used to process any suitable extensible web, including homogenous webs, monolayer webs, multilayer webs, composite webs. This would include assembled articles which had specific zones or regions that were extensible.

The preceding specific embodiments are illustrative of the practice of the invention. This invention may be suitably practiced in the absence of any element or item not specifically described in this document. The complete disclosures of all patents, patent applications, and publications are incorporated into this document by reference as if individually incorporated in total.

### EXAMPLES

The following examples are provided to enhance understanding of the present invention. The examples are not intended to limit the scope of the invention.

### Test Methods

Hysteresis:

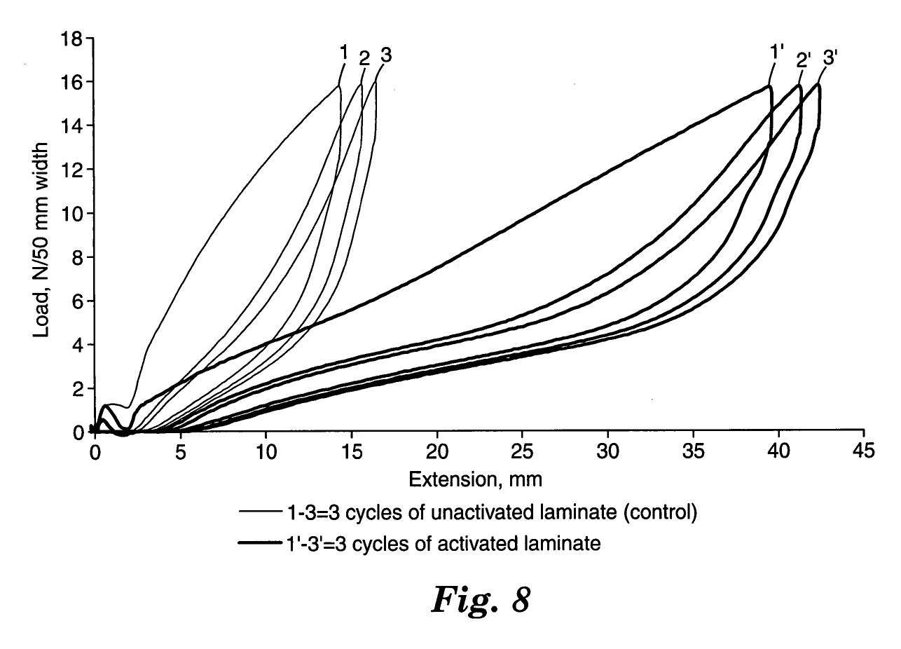

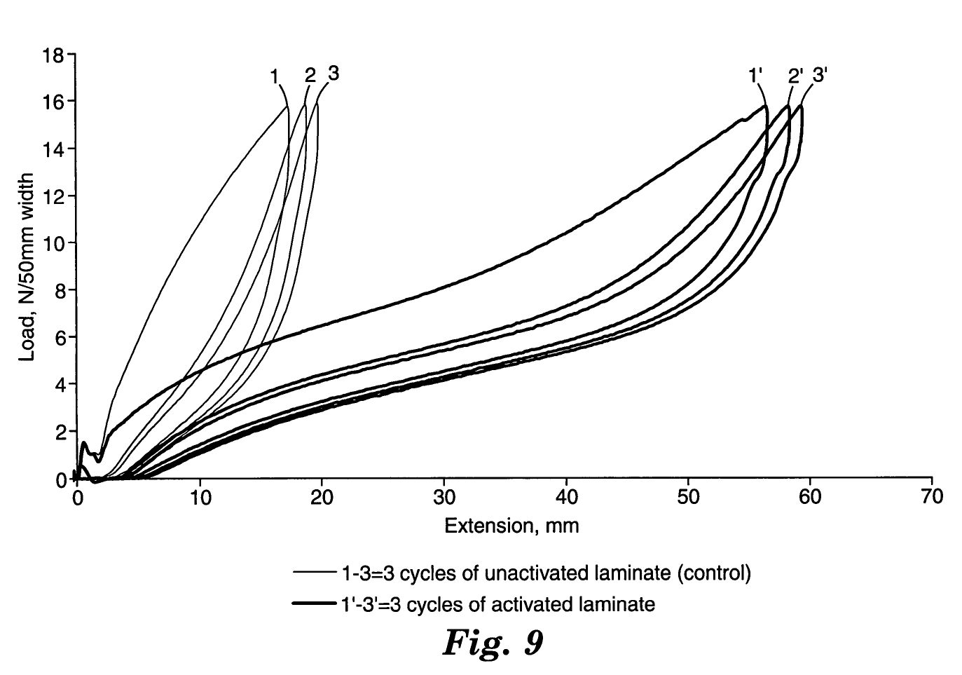

The hysteresis properties of the elastic/nonwoven laminates were measured. A 50 mm wide by 100 mm long piece of laminate was mounted in a tensile testing machine (INSTRON Model 55R1122, available from the Instron Corp.) with the upper and lower jaws 40 mm apart. Line contact jaws were used to minimize slip and breakage in the jaws. The jaws were then separated at a rate of 51 cm/minute until a load of 15 Newtons was recorded. The jaws were then held stationary for 1 second after which they returned to the zero elongation position. The jaws were again held stationary for 1 second and then separated at the same rate until a load of 16 Newtons was recorded. The cycle was repeated twice more for a total of 3 cycles. Two (2) replicates were tested with the results shown in FIGS. 8 and 9. The unstretched laminate was tested as a control and also the stretched laminates (Examples 1 and 2) as described below. FIGS. 8 and 9 show that the stretching process resulted in a laminate having significantly higher extension at a given load as evidenced by comparing the curves labeled 1′, 2′ and 3′ with the curves labeled 1, 2 and 3. The stretched material also had a significantly flatter (lower slope) stress-strain (hysteresis) curve than the unstretched material which is a desirable feature for an elastic material in many applications.

### Example 1

An elastic/nonwoven laminate web was prepared using the method disclosed in PCT publication WO 2004/082918.

A 40 mm diameter twin screw extruder fitted with a gear pump was used to deliver 75 grams/meter² of a molten elastomeric polymer blend consisting of a styrene-ethylenebutylene-styrene block copolymer (70%, KRATON G-1657, Kraton Polymers Inc., Houston, Tex.) and ultra low density polyethylene (30%, Engage 8452, Exxon Polymers Inc., Houston, Tex.) at a melt temperature of approximately 246° C. to a die. The die was positioned such that a film of molten polymer was extruded vertically downward into the interface region of a heated doctor blade and a cooled forming roll. The doctor blade was maintained at a temperature of 246° C. and the forming roll was maintained at a temperature of 30° C. by circulating chilled water through the interior of the roll. The doctor blade was held against the forming roll with a pressure of 450 pounds per lineal inch (788 Newtons/lineal cm).

Approximately 15 cm in width of the exterior surface of the forming roll was chemically etched so as to have a series of elliptically shaped posts arranged around the periphery of the roll. The posts were 1.6 mm wide and spaced 3.2 mm apart circumferentially (downweb) around the roll and 5 mm apart axially (crossweb) along the roll. The height of the posts was 63 microns. The tops (or lands) of the posts were the same height as the non-machined outermost areas of the roll such that when the doctor blade wiped extrudate from the roll, no extrudate was left on the lands of the posts resulting in an apertured polymeric film 15 cm in width. The extrudate was transferred from the forming roll to a lightly bonded high extension carded (HEC) nonwoven polypropylene substrate (Product FPN 332D) with a basis weight of 27 grams/meter² and a width of 22 cm from BBA Nonwovens (Simpsonville, S.C.) at a nip formed with a conformable backup roll (a steel core with a rubber cover having a durometer of 75 Shore A). The core of the backup roll was chilled by circulating water at a temperature of 5° C. The pressure exerted on the nip between the forming roll and the backup roll was 14 pounds per lineal inch (25 Newtons/lineal cm). To enhance the bond between the extrudate and the nonwoven, the nonwoven was sprayed in a swirl pattern with a hot melt adhesive (4.5 grams/meter², H9388, Bostik, Wauwatosa, Wis.) across the full width (22 cm) of the nonwoven. The 15 cm of extrudate was centered onto the 22 cm wide nonwoven, resulting in approximately 6 cm of outermost edge zones without elastomer. A second layer (22 cm width) of the same type of nonwoven, also sprayed with adhesive, was then laminated to the elastomer side of the previously created laminate using a rubber roll/steel roll nip, resulting in a 3 layer laminate in the middle 15 cm of the web and a 2 layer laminate in the outermost 6 cm of the web.

The laminate was then stretched in the cross-direction using an apparatus similar to that shown in FIG. 1. The orientation apparatus 12 consisted of 3 sets of driven rollers 7, 8, and 9. Each set of rollers consisted of a bank (subset) of 3 leading nip rollers 7″, 8″, and 9″ and a bank of 4 trailing nip rollers 7′, 8′ and 9′ as shown in FIG. 1a. All of the nip rollers were made of aluminum having a diameter of 7.6 cm, a thickness of 6.4 mm and were mounted on 2.5 cm diameter shafts. The outermost edge or land (4 mm width) of each nip roller was machined with a cross-hatched knurled pattern to increase the coefficient of friction of the roller against the laminate while stretching. Each bank of nip rollers was nipped against a polyurethane rubber coated steel roll 5 (30 durometer) 5.0 cm in diameter and 25.4 cm long. The leading and trailing banks of rollers were spaced 7.5 cm apart as measured from shaft center to shaft center. The individual rollers on each shaft were spaced 1.1 cm apart. The leading bank of rollers were offset in the cross direction from the trailing bank of rollers in each set as shown in FIG. 1a so as to create orientation zones. Roller set 8 was offset in the cross direction approximately 4 mm from roller set 7. Roller set 9 was offset from roller set 8 in the same manner. The leading bank of rollers was driven at a speed ratio of 1.6:1 relative to the trailing bank of rollers. The overall input web speed was 10 meters/min. The 60% overspeed created a machine direction tension on the web which then translated into a cross-direction force resulting in stretching of the web in the cross direction. Approximately 4.5 cm in width of the laminate web was stretched as a result of passing through the 3 sets of rollers. The stretched web was then collected into a roll for hysteresis testing as shown in FIG. 8

### Example 2

An elastic/nonwoven laminate web was prepared using the method disclosed in PCT publication WO 2004/082918 as described in Example 1 above.

The laminate was then stretched in the cross-direction using an apparatus similar to that shown in FIGS. 5 and 6. The orientation apparatus consisted of an underlying aluminum drive roll 48, 25.5 cm long and 15 cm in diameter fitted with seven annular wheels 49 & 50, concentric with roll 48, having a diameter of 15 cm and a thickness or width of 1 cm. The outer surfaces of the wheels where knurled with horizontal grooves and ridges to increase the coefficient of friction with the nonwoven laminate being processed through the apparatus. The wheels 49 starting with the outermost, were fixed to the same shaft as was the roll 48. The wheels 50 were not fixed to the shaft and thus were free to rotate independent of the rotation of the roll 48. The apparatus also consisted of seven rubber timing belts 5 mm in width and 40 cm long, of which only four are shown in FIG. 5 (41,42,43,46), which were used to nip or press the nonwoven laminate against the annular wheels. There were four sets of aluminum timing gears 5 cm in diameter and 1 centimeter width or thickness in cooperation with the belts. The first set consisted of four gears 46 mounted on a driven shaft and the second set consisted of three gears 46′ mounted on the same shaft as gears 46 and alternating in arrangement with gears 46. The gears 46 were not fixed to the shaft and thus were free to rotate at the same speed as roll 48, when cooperating with the fixed wheels 49. Gears 46′ were fixed to the shaft and driven at a 1.5:1 overspeed ratio relative to the roll 48, when cooperating with the freely rotating wheels 50. The third set consisted of four gears 45 mounted and fixed to a shaft. The fourth set consisted of three gears 47 mounted and fixed to a shaft. The rubber timing belts were used to connect the first and third sets of gears, and the second and fourth set of gears, creating nip zones.

Sixty (60) centimeter long sheets of the elastic/nonwoven laminate described above were hand fed at 5 meters/min into the nip zones of the apparatus created by the belts and the drive roll 48. The second set of gears 46′, in cooperation with the corresponding set of belts, being driven at a faster speed than the underlying drive roll 48, advanced the laminate in the machine direction in a leading nip lane having the same width (5 mm) as the belt used to form the nip zone. This advancement of the web was possible due to the underlying wheels 50 being free to rotate at the same speed as the gears 46′ and corresponding belts. The trailing nip lanes of material adjacent to the leading nip lanes, created by the first set of gears 46 and the corresponding belts, remained at the same speed as the slower drive roll 48 because the gears and belts were free to rotate and thus driven by the underlying wheels 49 that were fixed to the same shaft as slower roll 48. The 50% overspeed of gears 46′ created the orientation zone due to a machine direction tension on the laminate in the leading nip lane which in cooperation with the trailing nip lane translated into a cross-direction force or shear resulting in stretching of the web in the cross direction in approximately 5 mm wide alternating bands across the laminate. After passing through the apparatus the oriented regions retracted back to approximately the original dimensions due to the laminate having been activated, and recovering elastically. The activated sheet of laminate was then passed through the apparatus a second and third time, with a 3 mm offset each time to further activate the laminate. The activated laminates were then tested for their hysteresis or elastic properties as shown in FIG. 9

As briefly addressed above, the present invention can be used to process any suitable extensible web, including homogenous webs, monolayer webs, multilayer webs and composite webs. This would include assembled articles, which had specific zones or regions that were extensible.

The preceding specific embodiments are illustrative of the practice of the invention. This invention may be suitably practiced in the absence of any element or item not specifically described in this document. The complete disclosures of all patents, patent applications, and publications are incorporated into this document by reference as if individually incorporated in total.

What is claimed:

1. A method for orienting an extensible web in the cross direction comprising the steps of;
providing an extensible web traveling in a downweb direction at a first speed, the extensible web having a width and substantially continuous length in the first direction,
providing at least two nips offset in the cross direction of the web, at least one leading nip moving at a faster speed than a trailing nip where the degree of crossweb orientation is proportional to a ratio of the leading nip speed to the trailing nip speed, creating a crossweb orientation zone.

2. The method according to claim 1, wherein the ratio of leading nip speed to a trailing nip speed is at least 1.1.

3. The method according to claim 1, wherein the ratio of leading nip speed to a trailing nip speed is at least 1.2.

4. The method according to claim 1, wherein the ratio of the leading nip speed to trailing nip speed is less than 10.

5. The method according to claim 3, wherein the ratio of the leading nip speed to trailing nip speed is less than 5.

6. The method according to claim 3, wherein the leading nip and trailing nip are separated in the downweb direction by at least 0.1 cm.

7. The method according to claim 6, wherein the leading nip and trailing nip are separated in the crossweb direction by at least 0.5 cm.

8. The method according to claim 6, wherein the at least leading nip and trailing nip are separated in the downweb direction 0.1 to 20 cm and in the crossweb direction by at least 1 cm.

9. The method according to claim 6, wherein the leading nip and trailing nip are separated in the crossweb direction by at least 2 cm.

10. The method according to claim 8, wherein the leading nip to trailing nip downweb crossweb separation is from 0.5 to 10 cm.

11. The method according to claim 2, wherein the leading nip speed is faster than the first speed of the extensible web.

12. The method according to claim 11, wherein the trailing nip speed is less than or equal to the first speed of the extensible web.

13. The method according to claim 2, wherein the web is extended in the cross direction in the orientation zone by at least 10 percent.

14. The method according to claim 2, wherein the web is extended in the cross direction in the orientation zone by at least 50 percent.

15. The method according to claim 2, wherein there are two or more orientation zones provided in the cross direction of the web.

16. The method according to claim 2, wherein there are two or more orientation zones provided in the downweb direction.

17. The method according to claim 16, wherein two or more orientation zones provided in the downweb direction overlap at least in part.

18. The method according to claim 15, wherein the two or more orientation zones are in the same plane.

19. The method according to claim 18, wherein all the orientation zones and the extensible web into and out of the orientation zones are in substantially the same plane.

20. The method according to claim 2, wherein the extensible web is a laminate of an elastically extensible web and a relatively inelastic web.

21. The method according to claim 1 wherein at least the leading nip extends as a zone in the downweb direction.

22. The method of claim 21, wherein at least the leading nip zone extends in the downweb direction creating an orientation zone having a length of from 0 to 1 m.

23. The method of claim 21, wherein at least the leading nip zone extends in the downweb direction creating an orientation zone having a length of from 0.1 to 0.5 m.

24. An apparatus for orienting an extensible web in the cross direction comprising
feed means for providing a web path for an extensible web traveling in a downweb direction at a first speed, the extensible web having a width and substantially continuous length in the first direction,
at least two nips offset in the cross direction of the web path, at least one leading nip moving at a faster speed than a trailing nip where a degree of crossweb orientation is proportional to a ratio of the leading nip speed to the trailing nip speed, creating a crossweb orientation zone.

25. The apparatus according to claim 24, wherein the ratio of leading nip speed to a trailing nip speed is at least 1.1.

26. The apparatus according to claim 24, wherein the ratio of leading nip speed to a trailing nip speed is at least 1.2.

27. The apparatus according to claim 24, wherein the ratio of the leading nip speed to trailing nip speed is less than 10.

28. The apparatus according to claim 26, wherein the ratio of the leading nip speed to trailing nip speed is less than 5.

29. The apparatus according to claim 26, wherein the leading nip and trailing nip are separated in the downweb direction by at least 0.1 cm.

30. The apparatus according to claim 29, wherein the leading nip and trailing nip are separated in the crossweb direction by at least 0.5 cm.

31. The apparatus according to claim 29, wherein the at least leading nip and trailing nip are separated in the downweb direction 0.1 to 20 cm and in the crossweb direction by at least 1 cm.

32. The apparatus according to claim 29, wherein the leading nip and trailing nip are separated in the crossweb direction by at least 2 cm.

33. The apparatus according to claim 31, wherein the leading nip to trailing nip downweb crossweb separation is from 0.5 to 10 cm.

34. The apparatus according to claim 25, wherein the leading nip speed is faster than the first speed of the extensible web.

35. The apparatus according to claim 34, wherein the trailing nip speed is less than or equal to the first speed of the extensible web.

36. The method according to claim 25 wherein there are two or more orientation zones provided in the cross direction of the web.

37. The method according to claim 25, wherein there are two or more orientation zones provided in the downweb direction.

38. The method according to claim 37, wherein two or more orientation zones provided in the downweb direction overlap at least in part.

39. The method according to claim 24 wherein at least the leading nip extends as a zone in the downweb direction.

40. The method of claim 39, wherein at least the leading nip zone extends in the downweb direction creating an orientation zone having a length of from 0 to 1 m.

41. The method of claim 39, wherein at least the leading nip zone extends in the downweb direction creating an orientation zone having a length of from 0.1 to 0.5 m.
